(19) United States
(12) Patent Application Publication
(10) Pub. No.: US 2011/0001321 A1
(43) Pub. Date: Jan. 6, 2011

(54) Wind-operated torque generator for producing electric power, designed to be installed on top of roofs of both sloping and flat type

(76) Inventor: Giovanni Teglia, Piombino (IT)

Correspondence Address: SMIRMAN IP LAW, PLLC, P.O. BOX 80364, ROCHESTER, MI, 48308, US

(21) Appl. No.: 12/919,921

(22) PCT Filed: Mar. 3, 2009
(86) PCT No.: PCT/IT09/00078

§ 371 Date: Aug. 27, 2010

(30) Foreign Application Priority Data
Mar. 4, 2008 (IT) LI2008U000002
Mar. 31, 2008 (IT) LI2008A000002

(51) Int. Cl. F03D 3/04

(52) U.S. Cl. 290/55

(57) ABSTRACT

The invention is intended to exploit the force of the wind to generate a torque to be used for various purposes, among which, the production, via a mechanical coupling with alternators, of electric energy. The novelty lies in the new arrangement of the blades and of the eolian generator which makes it universally installable on the roof of any building owing to the very low visual and architectonic impact and its structural versatility. Its particular architecture makes it possible to fully exploit the roof effect and wall effect, these being phenomena that, by generating a rise in the wind's speed, allow the generator to have a production capacity exceeding the one of systems having equal dimensions.

Wind-operated torque generator for producing electric power, designed to be installed on top of roofs of both sloping and flat type.

### OBJECT

The serious energy crisis and the increase of pollutants and carbon dioxide in the atmosphere have urged the human being to seek for systems able to exploit renewable energies such as the sun and the wind.

This description will focus on the second type of energy, that is, the wind.

The invention relating to the present application has the object to provide a model of aeolian generator having constructional characteristics which allow it to be installed on almost any roof of public, private and industrial buildings and be used on such a large-scale as to give a positive contribution for saving energy and reducing emission of pollutants.

### STATE OF THE ART

Large plants have long been known for the production of electric power, which exploit the wind as motive element. They consist mostly in large propellers of several metres in diameter which are mounted on high trestles (Tab. 1). These plants are able to deliver many GWh/year but, however, they create problems of visual, acoustic and environmental impact, besides to be a danger for the flying fauna.

Aeolian generators of medium/small size also exist, so-called “mini aeolian generators”, which produce from one to few tents of kW. They can be grouped into two main categories: with horizontal axis and vertical axis arrangement.

Aeolian generators with horizontal axis are a miniature of the large plants above described (Tab. 2). They must be assembled on high trestles to avoid aerodynamic interferences with the ground, and they are noisy. With a propeller provided with a diameter of approximately four metres they can produce 1500 W with a wind blowing at 12 m/s. They orient themselves in the wind thanks to aerodynamic tails. They are suited for open spaces, for countryside, etc.

Those with vertical axis can exploit lighter winds in the order of 4-5 m/s, and, as they are slower, are far more silent. They can be constructed in a variety of forms (Tab. 3).

Their main characteristic is to compensate a modest efficiency with a simple construction and the possibility of exploiting the wind omnidirectionally. They also need to be provided with a suitable bearing basement since, in case of strong winds, the structure, about three metres high on average, and the anchoring basement are subject to heavy mechanical stresses. Accordingly, these generators are installed on trestles or flat roofs. Their visual impact is in any case quite evident.

In both cases, technical and environmental constrains significantly limit, in practice, a large-scale spreading of such mini-aeolian generators.

### DESCRIPTION

The proposed invention, hereinafter to be referred to as “system”, provides for suppressing these limits since it is devised and designed for a large-scale use thereof in population centres and elsewhere.

The novelty of the system lies in the original architecture of the generator which, owing to the arrangement of its blades, allows it to be installed on any sloping or flat roof in such a way—to be described hereinafter—as to fully exploit the “roof effect” for sloping roofs and the “wall effect” for buildings having flat roof.

Tab. 4 is a schematic view of the system in a configuration for installation on sloping roofs.

Tab. 5 is a schematic view of the system in a configuration for installation on buildings having flat roof.

Said system is, in practice, a generator with vertical axis rotated through 90° and turned, thereby, into a generator with horizontal axis.

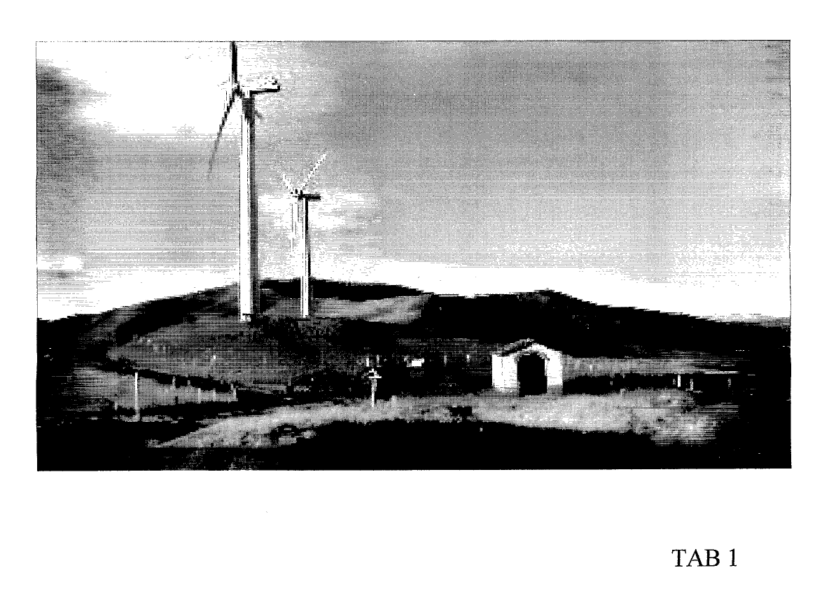

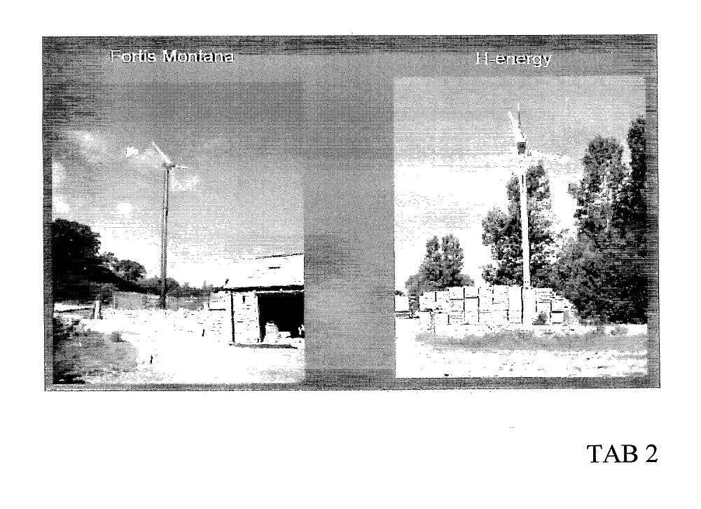

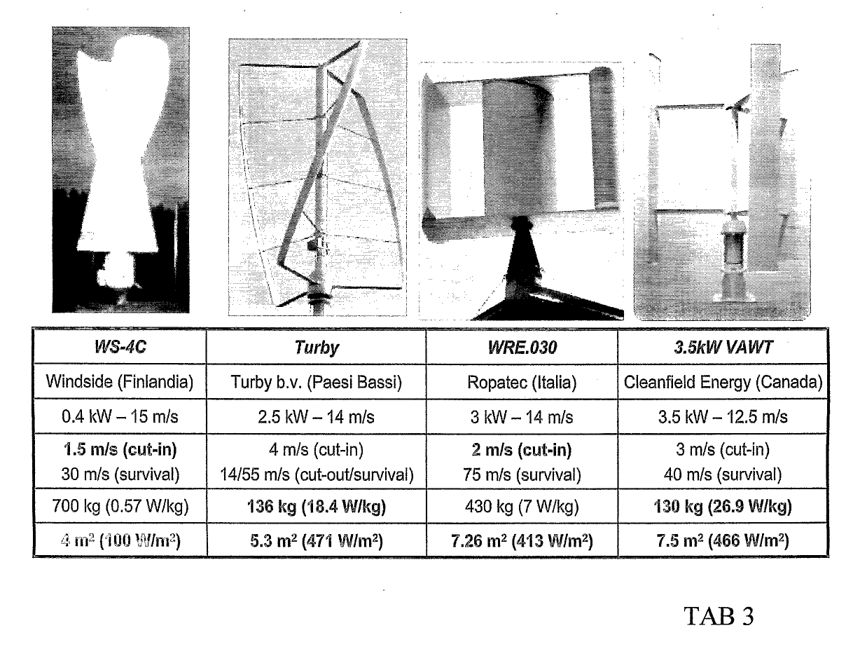

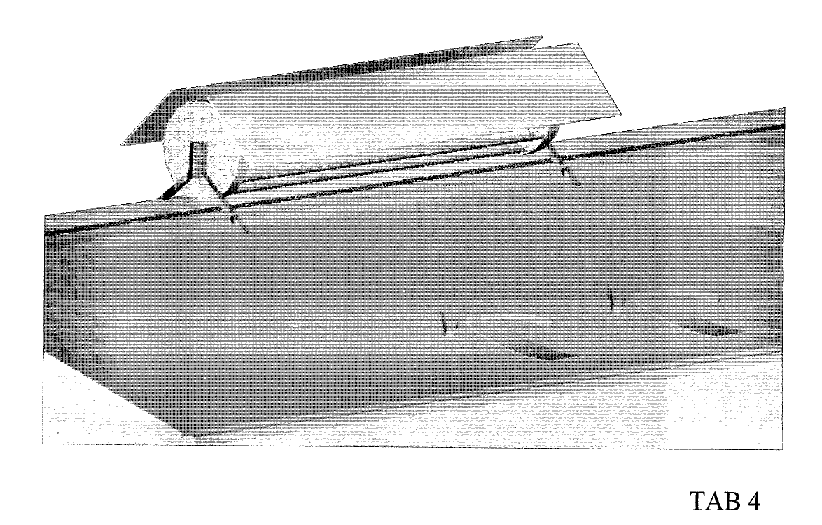

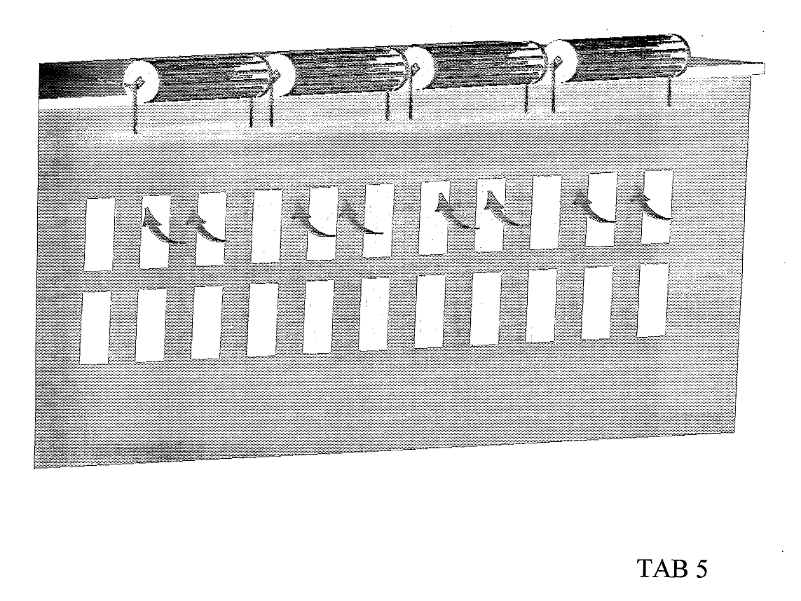

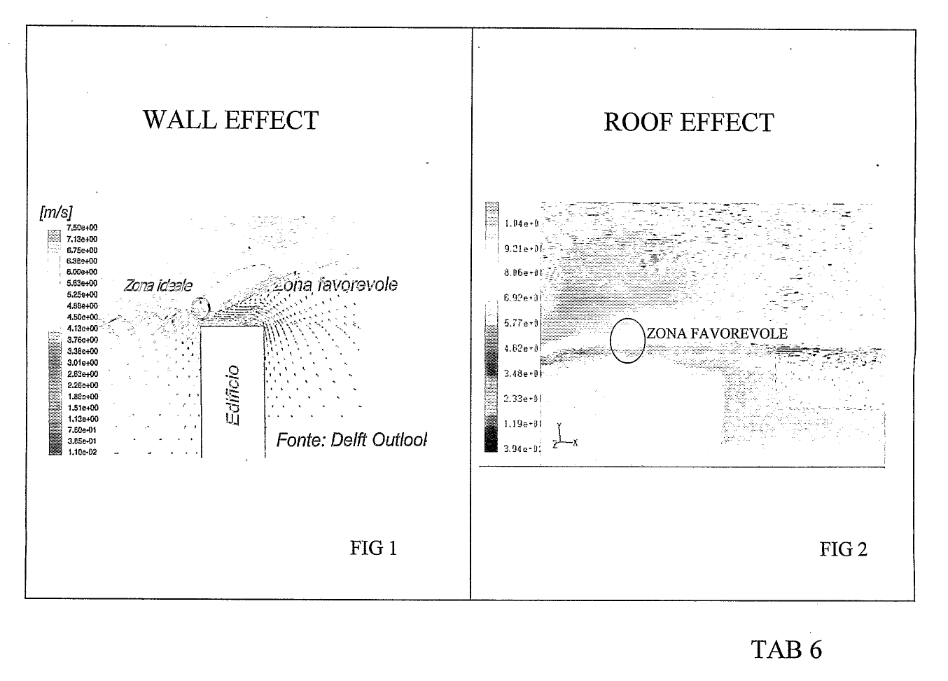

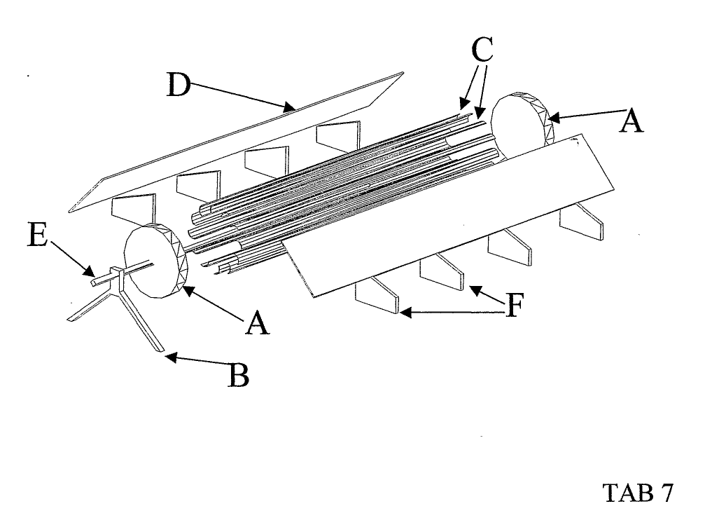

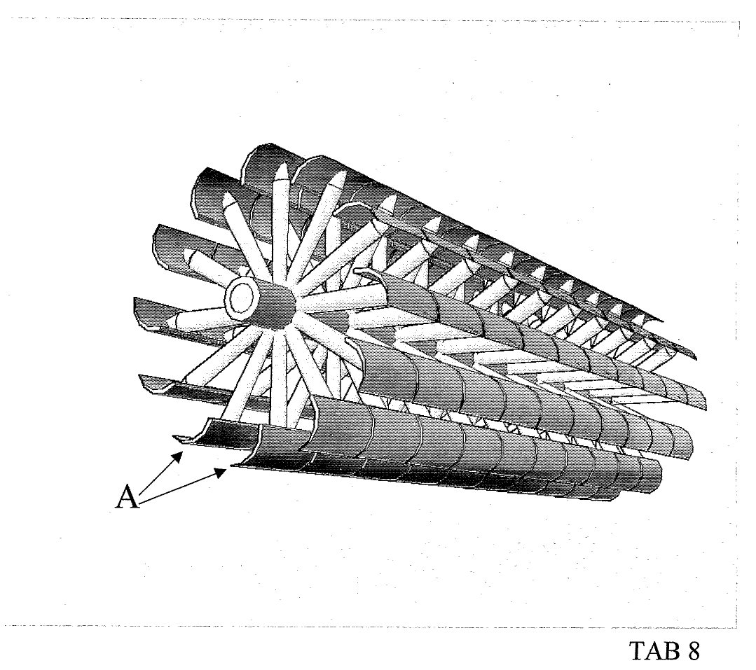

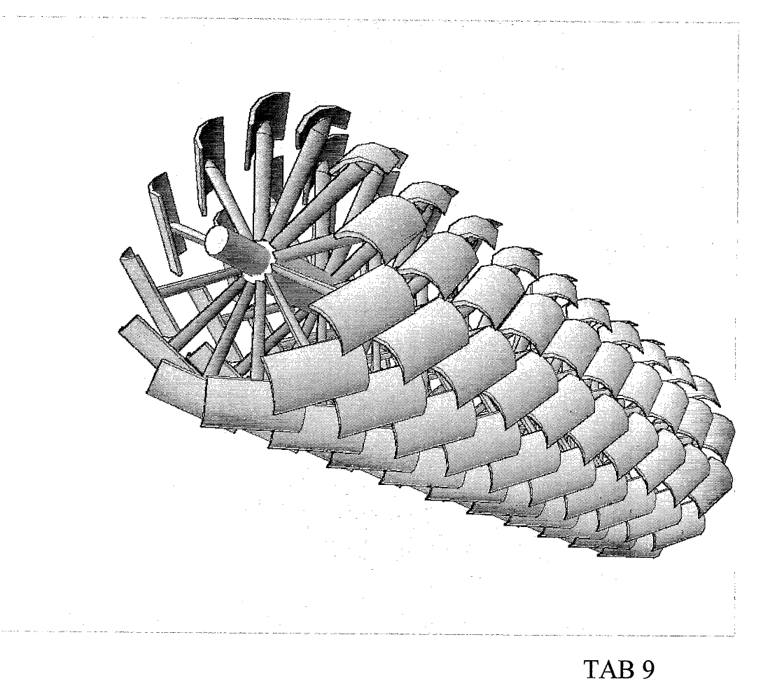

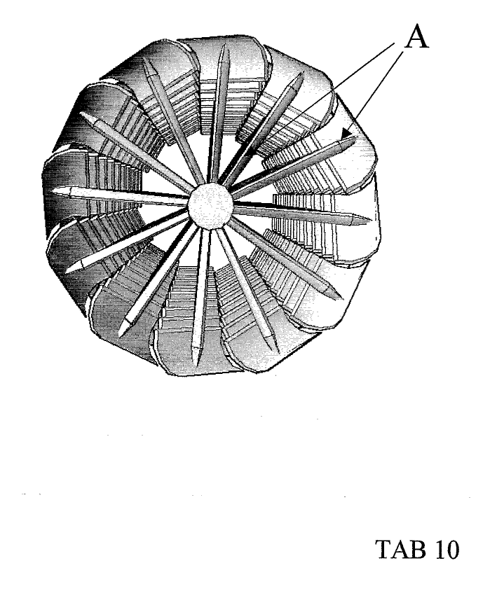

This modification is cause, actually, for a loss of the system's omnidirectional orientation capability but, on the other hand, gives rise to of very low visual impact of the same system and allows it to be hidden at will. In addition, it is also capable of exploiting the “roof effect”, that is, the increase of the wind speed owing to an increase in the pressure which stems from the inclination of the same roof. This effect occurs both in sloping (Tab. 6, FIG. 2) and flat (Tab. 6, FIG. 1) roofs, in the latter case being called “wall effect” as it defines the increase of wind speed on the wall's ridge point.

This phenomenon leads to an estimated rise of up to 20% in the wind's speed.

It is to be pointed out that the power obtainable from the wind is a cubed function of its speed, so that even a minimum rise of the wind is cause for a cubed variation of the power output. The described system is able to take out this power thanks to the original architecture above cited.

Those mechanical parts (stiffenings, anchorages, supports, etc.), that are not involved in the basic operation of the system, have been omitted in the description as they can vary according to the sizes and configurations.

Each blade may be formed by a plurality of sectors (Tab. 8/A) having dimensions varying according of those of the entire system. Each blade sector is fixed radially to the axis of rotation by means of an apparatus able to make it to turn through 180° so as to result positioned perpendicular to the wind's direction all the time. Assuming the axis of rotation is in North-South position on the wind rose, the motive element shown in Tab. 8 is in a configuration in which the wind is oriented against it at right angles, that is, 90° or 270°, with respect to the axis of rotation of the system. Tab. 9 shows the motive element in a configuration in which the winds is oriented against it at angles of 45° or 225°, with respect to the axis of rotation of the system. This ensures the system's highest efficiency also in case of variable wind's direction. The apparatus operating the rotation of the blades' sectors shall be interfaced with another apparatus able “to read” the direction of the wind and to deliver, therefore, suitable information to a further device of possibly mechanical, electrical, electronic, pneumatic type or a combination thereof, intended to operate the rotation of the blade's sectors. In a search for the highest efficiency of the to deliver, therefore, suitable information to a further device of possibly mechanical, electrical, electronic, pneumatic type or a combination thereof, intended to operate the rotation of the blade's sectors. In a search for the highest efficiency of the system, the radial supports which carry the blade's sectors could also be of a shape suited for a propeller or turbine (Tab: 10) able to impart a motion of rotation, and they will also be of variable geometry in view of the efficiency optimization. By “variable geometry” it is not meant the shape of the described elements, but rather the positioning thereof relative to the cartesian axes. This latter variability shall be given by the modification of the propeller made up of the radial supports (Tab. 10/A), the said modification being made through an apparatus similar to that used for changing the inclination of the blade's sectors. The two apparatuses operating the said variable geometries being able to be integrated to each other.

With reference to the exploded view of the system (Tab. 7) it can be seen that the latter is assimilable to a roller or rotor provided with blades of semi-circular profile able to exploit the force of the wind blowing perpendicular thereto.

The axis of the roller (Tab. 7/E) shall be borne by ball bearings on supports suited for installation on roofs, where they will be anchored by appropriate methods.

The blades, in the configuration in which they are stationary (Tab. 7/C), shall be engaged to the axis of rotation by side supports (Tab. 7/A).

The aeolian generator directional orientation capability and efficiency could be compensated and improved by both horizontal (Tab. 7/D) and vertical (Tab. 7/F) wind baffles.

Keyed on the axis of the roller, or mounted via transmissions capable of gearing up or down, an alternator shall be installed for producing electrical energy intended to be managed for meeting different requirements and then delivered.

1-16. (canceled)

17. An aeolian generator for producing electric energy and intended to be installed on roofs, comprising:
a rotor with substantially horizontal axis of rotation; and
stationary blades;
wherein said blades are operably engaged to said rotor by side supports, so as to exploit the increased wind speed at a ridge point.

18. An aeolian generator according to claim 17, wherein said ridge point is a roof ridge point.

19. An aeolian generator according to claim 17, wherein said ridge point is a wall ridge point.

20. An aeolian generator according to claim 17, wherein said blades extend substantially parallel to the axis of said rotor.

21. An aeolian generator according to claim 17, wherein said side supports are fixed at opposite ends of said blades.

22. An aeolian generator according to claim 17, wherein each of said blades is formed by a plurality of sectors.

23. An aeolian generator according to claim 17, wherein said side supports are of a shape suited for a propeller and/or turbine selectively operable to impart a rotational motion.

24. An aeolian generator according to claim 17, wherein the axis of the rotor is restrained, through bearings, onto supports provided with means for anchorage on a roof.

25. An aeolian generator according to claim 17, further comprising horizontal and/or vertical wind baffles.

26. An aeolian generator according to claim 17, further comprising an alternator installed on the axis of a roller and/or mounted via transmissions.
